(19) United States
(12) Patent Application Publication
(10) Pub. No.: US 2025/0140147 A1
(43) Pub. Date: May 1, 2025

(54) PANEL DRIVING CIRCUIT AND METHOD FOR DRIVING THE SAME, AND DISPLAY DEVICE

(71) Applicant: Beijing ESWIN Computing Technology Co., Ltd., Beijing (CN)

(72) Inventors: Hyunho CHO, Beijing (CN); Kyuyoung CHUNG, Beijing (CN)

(21) Appl. No.: 18/925,879

(22) Filed: Oct. 24, 2024

(30) Foreign Application Priority Data
Oct. 27, 2023 (CN) 202311412102.X

(51) Int. Cl. G09G 3/20

(52) U.S. Cl. CPC G09G 3/20; G09G 2310/0291

(57) ABSTRACT

A panel driving circuit includes a detection circuit, a control circuit, and an output circuit. The detection circuit outputs a first detection signal when a data change amount of a drive signal output through the drive channel is greater than a data amount threshold, and outputs a second detection signal when the data change amount of the drive signal output through the drive channel is not greater than the data amount threshold; the control circuit outputs a first control signal based on the first detection signal; and outputs a second control signal based on the second detection signal; and the output circuit outputs the drive signal to the display panel at a first slew rate based on the second control signal; and output the drive signal to the display panel at a second slew rate that is a boosted slew rate based on the first control signal.

### CROSS-REFERENCE TO RELATED APPLICATION

The present disclosure claims priority to Chinese Patent Application No. 202311412102.X, filed on Oct. 27, 2023 and entitled “PANEL DRIVING CIRCUIT AND METHOD FOR DRIVING THE SAME, AND DISPLAY DEVICE”, the entire content of which is incorporated herein by reference.

### TECHNICAL FIELD

The present disclosure relates to the field of display technologies, and in particular, relates to a panel driving circuit and a method for driving the same, and a display device.

### BACKGROUND

The panel driving circuit is a circuit for outputting drive signals to a display panel to drive the display panel to display a picture. For example, a source driver circuit providing data signals is also called a source driver. The source driver usually outputs drive signals to the display panel through a plurality of drive channels. Moreover, for each drive channel, the higher the slew rate of the source driver, the faster the slew rate when the source driver outputs different drive signals, and the better the display quality, Therefore, it is usually necessary to improve the slew rate of the source driver as much as possible to ensure better display quality, especially for large-size and high-resolution display products.

### SUMMARY

Embodiments of the present disclosure provide a panel driving circuit and a method for driving the same, and a display device. The technical solutions are as follows:

In one aspect, a panel driving circuit is provided. The panel driving circuit outputs drive signals to a display panel through a plurality of drive channels, and includes:
a detection circuit, configured to, for each of the plurality of drive channels, output a first detection signal in the case of detecting that a data change amount of a drive signal output through the drive channel is greater than a data amount threshold; and output a second detection signal in the case of detecting that the data change amount of the drive signal output through the drive channel is not greater than the data amount threshold;
a control circuit, configured to output a first control signal based on the first detection signal and an enable signal; and output a second control signal based on the second detection signal and the enable signal, wherein the first control signal indicates to boost a slew rate of the panel driving circuit in the drive channel, and the second control signal indicates not to boost the slew rate of the panel driving circuit in the drive channel; and
an output circuit, configured to output the drive signal to the display panel through the drive channel at a first slew rate based on the second control signal; and output the drive signal to the display panel through the drive channel at a second slew rate after the first slew rate is boosted based on the first control signal.

Optionally, the detection circuit is configured to:
determine that a data amount of the drive signal output through the drive channel is greater than the data amount threshold in the case of detecting that a difference between a data amount of the drive signal output through the drive channel at a current moment and a data amount of the drive signal output at another moment adjacent to the current moment is greater than a difference threshold; and
determine that the data amount of the drive signal output through the drive channel is not greater than the data amount threshold in the case of detecting that the difference between the data amount of the drive signal output through the drive channel at the current moment and the data amount of the drive signal output at another moment adjacent to the current moment is not greater than the difference threshold.

Optionally, the detection circuit includes:
a storage sub-circuit, configured to store the drive signal output through the drive channel at the current moment and the drive signal output through the drive channel at another moment adjacent to the current moment; and
a comparison sub-circuit, configured to compare whether the difference between the data amount of the drive signal output through the drive channel at the current moment and the data amount of the drive signal output at another moment adjacent to the current moment is greater than the difference threshold, and output the first detection signal and/or the second detection signal based on a comparison result.

Optionally, the control circuit includes:
a plurality of control sub-circuits in one-to-one correspondence with the plurality of drive channels, each of the control sub-circuits being configured to output the first control signal based on the received first detection signal and the enable signal; and output the second control signal based on the received second detection signal and the enable signal.

Optionally, the control sub-circuit includes a gate circuit; wherein
a first input terminal of the gate circuit is coupled with an enable signal terminal and configured to receive the enable signal provided by the enable signal terminal;
a second input terminal of the gate circuit is coupled with the detection circuit and configured to receive the first detection signal or the second detection signal output by the detection circuit; and
an output terminal of the gate circuit is coupled with the output circuit and configured to output the first control signal based on the first detection signal and the enable signal; and output the second control signal based on the second detection signal and the enable signal.

Optionally, the gate circuit includes an AND gate.

Optionally, the output circuit includes:
a plurality of output sub-circuits in one-to-one correspondence with the plurality of drive channels, each of the output sub-circuits being configured to output the drive signal to the display panel through a corresponding drive channel at the first slew rate based on the received second control signal; and output the drive signal to the display panel through a corresponding drive channel at the second slew rate based on the received first control signal.

Optionally, the output sub-circuit includes:
a level shifter, configured to convert a potential of a reference signal;
a decoder, configured to perform digital-to-analog conversion processing on the reference signal after potential conversion; and
an output buffer, configured to buffer the signal output after the digital-to-analog conversion processing into the drive signal at the first slew rate based on the second control signal and output to the display panel; and buffer the signal output after the digital-to-analog conversion processing into the drive signal at the second slew rate based on the first control signal, and output to the display panel.

Optionally, first input terminals of gate circuits in the plurality of control sub-circuits are coupled with the same enable signal terminal.

Optionally, potentials of the first detection signal and the second detection signal are different.

Optionally, potentials of the first control signal and the second control signal are different.

In another aspect, a method for driving a panel driving circuit is provided. The panel driving circuit outputs drive signals to a display panel through a plurality of drive channels, and the panel driving circuit includes a detection circuit, a control circuit and an output circuit; and the method includes:
for each of the plurality of drive channels, detecting, by the detection circuit, whether a data change amount of the drive signal output through the drive channel is greater than a data amount threshold;
controlling, by the control circuit, the output circuit to output the drive signal to the display panel through the drive channel at a first slew rate in the case of detecting that the data change amount of the drive signal output through the drive channel is not greater than the data amount threshold; and
controlling, by the control circuit, the output circuit to output the drive signal to the display panel through the drive channel at a second slew rate in the case of detecting that the data change amount of the drive signal output through the drive channel is greater than the data amount threshold;
wherein the second slew rate is a rate after the first slew rate is boosted.

Optionally, controlling, by the control circuit, the output circuit to output the drive signal to the display panel through the drive channel at the first slew rate includes:
outputting a second detection signal in the case of detecting, by the detection circuit, that the data change amount of the drive signal output through the drive channel is not greater than the data amount threshold;
outputting, by the control circuit, a second control signal based on the second detection signal and an enable signal, wherein the second control signal indicates not to boost a slew rate of the panel driving circuit in the drive channel; and
outputting, by the output circuit, the drive signal to the display panel through the drive channel at the first slew rate based on the second control signal.

Optionally, controlling, by the control circuit, the output circuit to output the drive signal to the display panel through the drive channel at the second slew rate includes:
outputting a first detection signal in the case of detecting, by the detection circuit, that the data change amount of the drive signal output through the drive channel is greater than the data amount threshold;
outputting, by the control circuit, a first control signal based on the first detection signal and the enable signal, wherein the first control signal indicates to boost the slew rate of the panel driving circuit in the drive channel; and
outputting, by the output circuit, the drive signal to the display panel through the drive channel at the second slew rate based on the first control signal.

Optionally, detecting, by the detection circuit, whether the data change amount of the drive signal output through the drive channel is greater than the data amount threshold includes:
detecting whether a difference between a data amount of the drive signal output through the drive channel at a current moment and a data amount of the drive signal output at another moment adjacent to the current moment is greater than a difference threshold;
determining that the data amount of the drive signal output through the drive channel is greater than the data amount threshold in the case of detecting that the difference between the data amount of the drive signal output through the drive channel at the current moment and the data amount of the drive signal output at another moment adjacent to the current moment is greater than the difference threshold; and
determining that the data amount of the drive signal output through the drive channel is not greater than the data amount threshold in the case of detecting that the difference between the data amount of the drive signal output through the drive channel at the current moment and the data amount of the drive signal output at another moment adjacent to the current moment is not greater than the difference threshold.

Optionally, the detection circuit includes a storage sub-circuit and a comparison sub-circuit; the storage sub-circuit stores the drive signal output through the drive channel at the current moment and the drive signal output through the drive channel at another moment adjacent to the current moment; and
detecting whether the difference between the data amount of the drive signal output through the drive channel at the current moment and the data amount of the drive signal output at another moment adjacent to the current moment is greater than the difference threshold includes:
comparing, by the comparison sub-circuit, whether the difference between the data amount of the drive signal output through the drive channel at the current moment and the data amount of the drive signal output at another moment adjacent to the current moment is greater than the difference threshold.

Optionally, the control circuit includes a plurality of control sub-circuits in one-to-one correspondence with the plurality of drive channels; the output circuit includes a plurality of output sub-circuits in one-to-one correspondence with the plurality of drive channels;
controlling, by the control circuit, the output circuit to output the drive signal to the display panel through the drive channel at the first slew rate in the case of detecting that the data change amount of the drive signal output through the drive channel is not greater than the data amount threshold includes:
controlling, by the control sub-circuit corresponding to the drive channel, a corresponding output sub-circuit to output the drive signal to the display panel through the drive channel at the first slew rate; and
controlling, by the control circuit, the output circuit to output the drive signal to the display panel through the drive channel at the second slew rate in the case of detecting that the data change amount of the drive signal output through the drive channel is greater than the data amount threshold includes:
controlling, by the control sub-circuit corresponding to the drive channel, the corresponding output sub-circuit to output the drive signal to the display panel through the drive channel at the second slew rate.

Optionally, potentials of the first detection signal and the second detection signal are different.

Optionally, potentials of the first control signal and the second control signal are different.

In yet another aspect, a display device is provided. The display device includes: a display panel and a panel driving circuit;
wherein the panel driving circuit is configured to output drive signals to the display panel through a plurality of drive channels; the display panel is configured to display a picture based on the drive signals; and
the panel driving circuit includes:
a detection circuit, configured to, for each of the plurality of drive channels, output a first detection signal in the case of detecting that a data change amount of a drive signal output through the drive channel is greater than a data amount threshold; and output a second detection signal in the case of detecting that the data change amount of the drive signal output through the drive channel is not greater than the data amount threshold;
a control circuit, configured to output a first control signal based on the first detection signal and an enable signal; and output a second control signal based on the second detection signal and the enable signal, wherein the first control signal indicates to boost a slew rate of the panel driving circuit in the drive channel, and the second control signal indicates not to boost the slew rate of the panel driving circuit in the drive channel; and
an output circuit, configured to output the drive signal to the display panel through the drive channel at a first slew rate based on the second control signal; and output the drive signal to the display panel through the drive channel at a second slew rate after the first slew rate is boosted based on the first control signal.

### BRIEF DESCRIPTION OF DRAWINGS

To describe the technical solutions of the embodiments of the present disclosure more clearly, the following briefly introduces the accompanying drawings required for describing the embodiments, Apparently, the accompanying drawings in the following description show only some embodiments of the present disclosure, and a person of ordinary skill in the art may still derive other drawings from these accompanying drawings without creative efforts.

FIG. 1 is a schematic structural diagram of a panel driving circuit according to some embodiments of the present disclosure;

FIG. 2 is a schematic structural diagram of another panel driving circuit according to some embodiments of the present disclosure;

FIG. 3 is a schematic structural diagram of yet another panel driving circuit according to some embodiments of the present disclosure;

FIG. 4 is a schematic structural diagram of still a further panel driving circuit according to some embodiments of the present disclosure;

FIG. 5 is a schematic structural diagram of still a further panel driving circuit according to some embodiments of the present disclosure;

FIG. 6 is a schematic structural diagram of still a further panel driving circuit according to some embodiments of the present disclosure;

FIG. 7 is an output simulation result of a panel driving circuit with no slew rate boost according to some embodiments of the present disclosure;

FIG. 8 is an output simulation result of a panel driving circuit with general slew rate boost according to some embodiments of the present disclosure:

FIG. 9 is an output simulation result of a panel driving circuit with proposed slew rate boost according to some embodiments of the present disclosure;

FIG. 10 is a flowchart of a method for driving a panel driving circuit according to some embodiments of the present disclosure; and

FIG. 11 is a schematic structural diagram of a display device according to some embodiments of the present disclosure.

### DETAILED DESCRIPTION

To make the objectives, technical solutions, and advantages of the present disclosure clearer, the following further describes the embodiments of the present disclosure in detail with reference to the accompanying drawings.

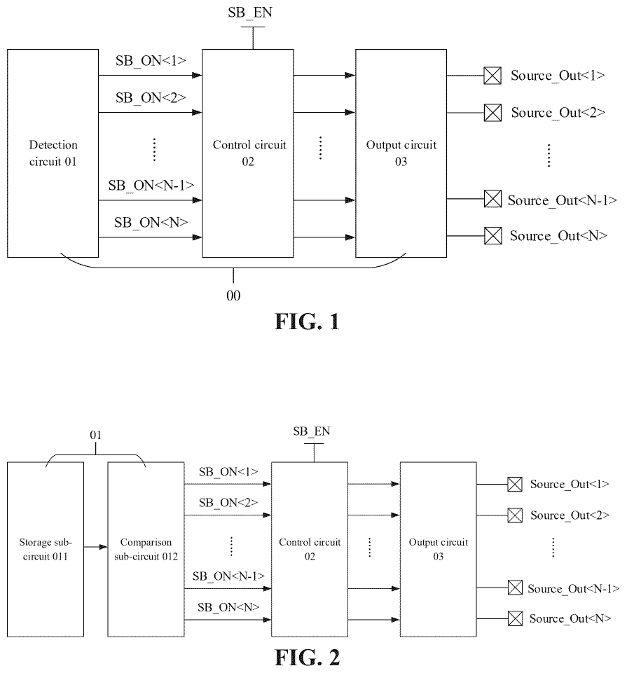

FIG. 1 is a schematic structural diagram of a panel driving circuit according to some embodiments of the present disclosure. As shown in FIG. 1, the panel driving circuit 00 may output drive signals to a display panel through a plurality of drive channels.

Exemplarily, the panel driving circuit 00 shown in FIG. 1 outputs the drive signals through N drive channels, and N is an integer greater than 1. Here, the panel driving circuit 00 may refer to a source driver circuit, and correspondingly, the output drive signals may refer to data signals, Based on this, referring to FIG. 1, it can be seen that the source driver circuit may be coupled with the display panel (not shown in FIG. 1) through N source output terminals Source_Out<1>, Source_Out2> . . . Source_Out<N−1> and Source_Out<N>, and the N source output terminals and the N drive channels are in one-to-one correspondence.

In addition, the display panel generally includes a plurality of lines and a plurality of columns of pixels, and the source driver circuit may be coupled with the plurality of lines of pixels in the display panel through the N source output terminals in one-to-one correspondence, so as to output the data signals to the plurality of lines of pixels and drive the plurality of lines of pixels to emit light, such that the display panel displays pictures, and correspondingly, the data signals are also called display signals. In addition, the coupling mode and transmission mode here are only schematic illustrations.

With continued reference to FIG. 1, it can be seen that the panel driving circuit 00 described in the embodiments of the present disclosure includes a detection circuit 01, a control circuit 02, and an output circuit 03.

The detection circuit 01 is configured to, for each of the plurality of (for example, N) drive channels, output a first detection signal in the case of detecting that a data change amount of the drive signal output through the drive channel (which may be considered as a current drive channel) is greater than a data amount threshold. In the case of detecting that the data change amount of the drive signal output through the drive channel is not greater than the data amount threshold, a second detection signal is output.

Optionally, the data amount threshold may be set in advance to measure the size of the data change amount. In the case that the data change amount is greater than the data amount threshold, it can be considered that the data change amount of the drive signal output through the current drive channel is larger, and the current drive channel belongs to a drive channel with a large data amount change. In the case that the data change amount is not greater than the data amount threshold, it can be considered that the data change amount of the drive signal output through the current drive channel is smaller, and the current drive channel belongs to a drive channel with a small data amount change. For the drive signal including the data signal, the data change amount here may refer to a potential change amount of the data signal at different moments.

The detection circuit 01 may output the first detection signal for the drive channel with large data amount change; the detection circuit 01 may output the second detection signal for the drive channel with small data amount change. The first detection signal and the second detection signal are different. For example, the potential of the first detection signal may be a high potential relative to the potential of the second detection signal, that is, the potential of the first detection signal may be a high (H) potential and the potential of the second detection signal may be a low (L) potential. When expressed in binary, the high potential may be 1 and the low potential may be 0. In some other embodiments, the potential of the first detection signal may also be a low potential relative to the potential of the second detection signal.

The control circuit 02 is configured to output a first control signal based on the first detection signal and an enable signal, and output a second control signal based on the second detection signal and the enable signal.

The first control signal is configured to indicate to boost a slew rate of the panel driving circuit in the drive channel (i.e., the current drive channel), and is suitable for a slew rate boost (SB) solution. The second control signal is configured to indicate not to boost the slew rate of the panel driving circuit in the drive channel. That is, based on the above descriptions, it can be known that the slew rate boost solution may be applied to the drive channel with large data amount change, but not to the drive channel with small data amount change or no data amount change. In this way, compared with uniformly boosting the slew rate of the source driver for the plurality of drive channels, the required consumption current can be less.

In addition, referring to FIG. 1, it can also be seen that the control circuit 02 may be respectively coupled with the detection circuit 01 and an enable signal terminal SB_EN providing the enable signal to receive the first detection signal/second detection signal output by the detection circuit 01 and the enable signal provided by the enable signal terminal SB_EN. Furthermore, for N drive channels, the control circuit 02 may be coupled with the detection circuit 01 through N terminals SB_ON<1>, SB_ON<2> . . . SB_ON<N−1> and SB_ON<N> to receive the first detection signal/second detection signal output by the detection circuit 01 for different drive channels.

Optionally, a potential of the enable signal may be a high (H) potential, expressed by 1. Based on the above embodiments, it can be known that for any one of the plurality of drive channels, the control circuit 02 can output the first control signal only when receiving the first detection signal of high potential H and the enable signal of high potential at the same time, so as to indicate to boost the slew rate; and the control circuit 02 can output the second control signal when receiving the second detection signal of low potential L and the enable signal of high potential at the same time, so as to indicate not to boost the slew rate.

The output circuit 03 is configured to output the drive signal to the display panel through the drive channel at a first slew rate based on the second control signal; and output the drive signal to the display panel through the drive channel at a second slew rate after the first slew rate is boosted based on the first control signal. That is, based on the above descriptions, it can be known that the output circuit 03 may work at a relatively low slew rate to output the drive signal for the drive channel with a small data amount change or no data amount change. For the drive channel with large data amount change, the slew rate of the output circuit 03 may be boosted, such that the output circuit 03 can work at a relatively high slew rate after the boost to output the drive signal, so as to reduce current consumption.

In addition, referring to FIG. 1, it can also be seen that the output circuit 03 may be respectively coupled with the control circuit 02 and the display panel to receive the first control signal/second control signal output by the control circuit 02 and output the drive signals to the display panel. Moreover, for each of the N drive channels, the output circuit 03 may be coupled with the control circuit 02 through N interfaces (not shown) to receive the first control signal/second control signal output by the control circuit 02 for different drive channels. Besides, based on the above descriptions, the output circuit 03 may be coupled with the display panel through N source output terminals Source_Out<1>, Source_Out<2> . . . Source_Out<N−1> and Source_Out<N> to output the drive signals through the N drive channels.

In summary, the embodiments of the present disclosure provide a panel driving circuit. The panel driving circuit includes a detection circuit, a control circuit, and an output circuit. For each of the plurality of drive channels, the detection circuit can output the first detection signal to the control circuit when the data change amount of the drive signal output through the drive channel is larger, so as to indicate the control circuit to output the control signal boosting the slew rate to the output circuit, such that the output circuit works at the boosted slew rate; the second detection signal can be output to the control circuit when the data change amount of the drive signal output through the drive channel is smaller, so as to indicate the control circuit to output the control signal not boosting the slew rate to the output circuit. That is, the slew rate can be boosted only for the drive channels with larger data change amount. In this way, the current consumption can be reduced.

Optionally, for each of the plurality of drive channels, the detection circuit 01 described in the embodiments of the present disclosure may be configured as follows.

In the case of detecting that a difference between a data amount of the drive signal output through the drive channel at a current moment and a data amount of the drive signal output at another moment adjacent to the current moment (for example, the next moment) is greater than a difference threshold, it is determined that the data amount of the drive signal output through the drive channel is greater than the data amount threshold.

In the case of detecting that the difference between the data amount of the drive signal output through the drive channel at the current moment and the data amount of the drive signal output at another moment adjacent to the current moment is not greater than the difference threshold, it is determined that the data amount of the drive signal output through the drive channel is not greater than the data amount threshold.

That is, for each drive channel, the detection circuit 01 may determine whether the data amount of the drive signal output through the drive channel is greater than the data amount threshold by comparing the data amounts of the drive signals output through the drive channel at two adjacent moments, that is, determine whether the current drive channel belongs to a drive channel with small data amount change or no data amount change or large data amount change.

Optionally, as described above, the plurality of drive channels and the plurality of source output terminals may be in one-to-one correspondence, and the plurality of source output terminals are coupled with the plurality of lines of pixels in one-to-one correspondence. Accordingly, the plurality of drive channels and the plurality of lines of pixels may be in one-to-one correspondence. Based on this, for each of the plurality of drive channels, the drive signal output through the drive channel at the current moment may refer to the data signal output to the corresponding line of pixels at the current moment, which is also called current moment display data; and the drive signal output through the drive channel at the next moment may refer to the data signal output to the corresponding line of pixels at the next moment, which is also called next moment display data. The current moment and the next moment are two adjacent moments.

Based on this, FIG. 2 shows a schematic structural diagram of another panel driving circuit according to some embodiments of the present disclosure. Referring to FIG. 2, it can be seen that the detection circuit 01 described in the embodiment of the present disclosure may include a storage sub-circuit 011 and a comparison sub-circuit 012. For each of the plurality of drive channels:
the storage sub-circuit 011 may be configured to store the drive signal output through the drive channel at the current moment and the drive signal output through the drive channel at another moment adjacent to the current moment. That is, the storage sub-circuit 011 may be set to store the current moment display data and the next moment display data; and
the comparison sub-circuit 012 may be configured to compare whether the difference between the data amount of the drive signal output through the drive channel at the current moment and the data amount of the drive signal output at another moment adjacent to the current moment is greater than the difference threshold, and output the first detection signal and/or the second detection signal based on the comparison result. That is, the comparison sub-circuit 012 may be set to compare the current moment display data with the next moment display data to determine whether the data amount of the drive signal output through the drive channel is greater than the data amount threshold.

Thus, referring to FIG. 2, it can also be seen that the comparison sub-circuit 012 may be coupled with the storage sub-circuit 011, so as to acquire the current moment display data and the next moment display data stored by the storage sub-circuit 011.

Optionally, the storage sub-circuit 011 may include a line memory. The comparison sub-circuit 012 may include a logic circuit executing a self-adaptive, selective, and adjustable slew rate boost algorithm, and a selection circuit. The selection circuit may include registers: SB_MODE and SB_OPT[2:0]. In some other embodiments, it may also include SB_CTRL[2:0].

Referring to Table 1, it can be seen that the SB_MODE stores a selection option of a slew rate boost method. When the SB_MODE is 0, the operation executes “a general slew rate boost solution is selected, that is, a general SB design: the SB_ON<X> of the plurality of drive channels is all set high by H to uniformly boost the slew rate of the plurality of drive channels”. When the SB_MODE is 1, the operation executes “a proposed slew rate boost solution according to some embodiments of the present disclosure is selected, that is, a proposed SB design: the SB_ON<X> of the X^{th} drive channel is set high by H or low by L according to data change amount of the X^{th} drive channel, so as to flexibly boost the slew rate based on the data change amount. As described in the above embodiments, the slew rate boost solution may be applied only to the drive channels with large data amount change in the plurality of drive channels. Compared with the SB_MODE being 0, the purpose of optimizing the current consumption can be achieved.

Assuming that N drive channels are included, X may refer to an integer greater than or equal to 1 and less than or equal to N, and refers to the X^{th} drive channel in the N drive channels. The following embodiments are identical and will not be repeated in detail.

TABLE 1

| SB_MODE | Operation |
|---|---|
| 0 | General SB: the SB_ON<X> of the plurality of drive channels is all set high by H |
| 1 | Proposed SB: the SB_ON<X> of the X^{th} drive channel is set high by H or low by L |
| | according to data change amount of the X^{th} drive channel |

Referring to Table 2, it can be seen that the SB_OPT[2:0] stores a different option of boosting the slew rate to optimize the current consumption according to some embodiments of the present disclosure. 000 indicates execution operation: for a 1023 display gray scale, in the case that the data change amount of the X^{th} drive channel in the N drive channels reaches 100%, the SB_ON<X> of the X^{th} drive channel is set high by H to boost the slew rate of the X^{th} drive channel. The rest of the execution operations indicated by 001 to 111 are based on the same principle, and will not be repeated in detail one by one.

TABLE 2

| SB_OPT[2:0] | Operation |
|---|---|
| 000 | In the case that the data change amount of the X^{th} drive channel reaches 100% |
| | (1023 gray scale), the SB_ON<X> of the X^{th} drive channel is set high by H |
| 001 | In the case that the data change amount of the X^{th} drive channel exceeds 87.5% |
| | (895 gray scale), the SB_ON<X> of the X^{th} drive channel is set high by H |
| 010 | In the case that the data change amount of the X^{th} drive channel exceeds 75.0% |
| | (767 gray scale), the SB_ON<X> of the X^{th} drive channel is set high by H |
| 011 | In the case that the data change amount of the X^{th} drive channel exceeds 62.5% |
| | (639 gray scale), the SB_ON<X> of the X^{th} drive channel is set high by H |
| 100 | In the case that the data change amount of the X^{th} drive channel exceeds 50.0% |
| | (511 gray scale), the SB_ON<X> of the X^{th} drive channel is set high by H |
| 101 | In the case that the data change amount of the X^{th} drive channel exceeds 37.5% |
| | (383 gray scale), the SB_ON<X> of the X^{th} drive channel is set high by H |
| 110 | In the case that the data change amount of the X^{th} drive channel exceeds 25.0% |
| | (255 gray scale), the SB_ON<X> of the X^{th} drive channel is set high by H |
| 111 | In the case that the data change amount of the X^{th} drive channel exceeds 12.5% |
| | (127 gray scale), the SB_ON<X> of the X^{th} drive channel is set high by H |

Referring to Table 3, it can be seen that the SB_CTRL[2:0] stores different options for boosting the slew rate and the corresponding current adjustment according to some embodiments of the present disclosure, 000 indicates execution operation: a current corresponding to the slew rate boost is set to the minimum value, and correspondingly, the slew rate at this time is also correspondingly the minimum. 001 indicates execution operation; the current corresponding to the slew rate boost is set to be greater than the current expressed by 000, and correspondingly, the slew rate at this time is greater than the slew rate expressed by 000. The rest of the execution operations indicated by 010 to 111 are based on the same principle, and will not be repeated in detail one by one.

TABLE 3

| SB_CTRL[2:0] | Operation |
|---|---|
| 000 | Current corresponding to slew rate boost = minimum |
| | &slew rate = minimum |
| 001 | Current corresponding to slew rate boost = greater than SB_CTRL[2:0] = 000 |
| | &slew rate = faster than SB_CTRL[2:0] = 000 |
| 010 | Current corresponding to slew rate boost = greater than SB_CTRL[2:0] = 001 |
| | &slew rate = faster than SB_CTRL[2:0] = 001 |
| 011 | Current corresponding to slew rate boost = greater than SB_CTRL[2:0] = 010 |
| | &slew rate = faster than SB_CTRL[2:0] = 010 |
| 100 | Current corresponding to slew rate boost = greater than SB_CTRL[2:0] = 011 |
| | &slew rate = faster than SB_CTRL[2:0] = 011 |
| 101 | Current corresponding to slew rate boost = greater than SB_CTRL[2:0] = 100 |
| | &slew rate = faster than SB_CTRL[2:0] = 100 |
| 110 | Current corresponding to slew rate boost = greater than SB_CTRL[2:0] = 101 |
| | &slew rate = faster than SB_CTRL[2:0] = 101 |
| 111 | Current corresponding to slew rate boost = maximum |
| | &slew rate = fastest |

Based on the above Table 1 to Table 3, Table 4 also shows a simulation result. The simulation result of three driving methods is shown: 1. “no slew rate boost, that is, no SB design”; 2, “general slew rate boost solution, that is, the general SB design, to uniformly improve the slew rate”; 3. “proposed slew rate boost solution according to the embodiments of the present disclosure, that is, the proposed SB design, to flexibly boost the slew rate according to the data amount change”. The simulation result shown includes: a rising edge time length and a falling edge time length under about 10% to 90% of a delay time length, in μs; and the current consumption of one drive channel in different display modes, in μA, the different display modes including displaying black, displaying gray, displaying white, displaying red, displaying green, and displaying blue respectively. Besides, the current consumption average values and current consumption ratios in different driving methods are also shown. By comparison, it can be seen that the current consumption ratio of the proposed SB is obviously lower than that of the general SB, From this, it can be further seen that the embodiment of the present disclosure can effectively reduce the current consumption by boosting the slew rate only for the drive channels with larger data change amount. Furthermore, high-resolution display products can be reliably driven.

TABLE 4

| | | | No | General | Proposed |
|---|---|---|---|---|---|
| Driving methods | | | SB | SB | SB |
| Delay time length (10%-90%) | | Rising | 1.485 | 0.576 | 0.576 |
| | | Falling | 1.488 | 0.547 | 0.547 |
| Current consumption of one drive | Display | Black | 1.85 | 2.32 | 1.85 |
| channel | mode | Gray | 2.22 | 2.58 | 2.22 |
| | | White | 1.77 | 2.14 | 1.77 |
| | | Red | 22.93 | 23.33 | 23.14 |
| | | Green | 1.81 | 2.18 | 1.81 |
| | | Blue | 22.93 | 23.33 | 23.14 |
| | | Average | 8.92 | 9.31 | 8.99 |
| | | Ratio | 100% | 104% | 101% |

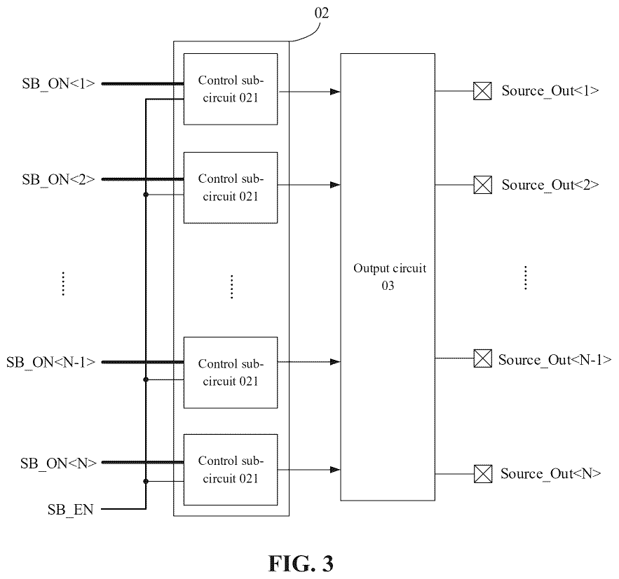

Optionally, FIG. 3 is a schematic structural diagram of yet another panel driving circuit according to some embodiments of the present disclosure. Referring to FIG. 3, it can be seen that the control circuit 02 described in the embodiments of the present disclosure may include a plurality of control sub-circuits 021 in one-to-one correspondence with the plurality of drive channels. For example, the N control sub-circuits 021 are in one-to-one correspondence with the N drive channels. Besides, each control sub-circuit 021 may be configured to:
output the first control signal based on the received first detection signal and the enable signal; and
output the second control signal based on the received second detection signal and the enable signal.

Thus, referring to FIG. 3, it can also be seen that the N control sub-circuits 021 may be coupled with the detection circuit 01 (not shown in FIG. 3) through N terminals SB_ON<1>, SB_ON<2> . . . SB_ON<N−1>, and SB_ON<N>. On the basis that the detection circuit 01 includes the storage sub-circuit 011 and the comparison sub-circuit 012, the N control sub-circuits 021 may be coupled with the comparison sub-circuit 012 in the detection circuit 01.

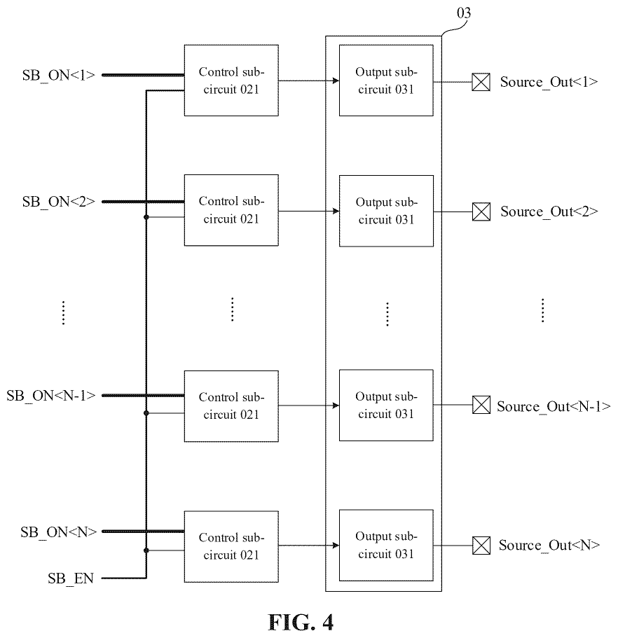

Optionally, FIG. 4 is a schematic structural diagram of still a further panel driving circuit according to some embodiments of the present disclosure. Referring to FIG. 4, it can be seen that the output circuit 03 described in the embodiments of the present disclosure may include a plurality of output sub-circuits 031 in one-to-one correspondence with the plurality of drive channels. For example, the N output sub-circuits 031 are in one-to-one correspondence with the N drive channels. Besides, each output sub-circuit 031 may be configured to:
output the drive signal to the display panel through the corresponding drive channel at the first slew rate based on the received second control signal, and output the drive signal to the display panel through the corresponding drive channel at the second slew rate based on the received first control signal.

Thus, referring to FIG. 4, it can also be seen that the N output sub-circuits 031 may be coupled with the control circuit 02 through N interfaces. On the basis that the control circuit 02 includes the N control sub-circuits 021 in one-to-one correspondence with the N drive channels, the N output sub-circuits 031 may be coupled with the N control sub-circuits 021 in one-to-one correspondence through the N interfaces.

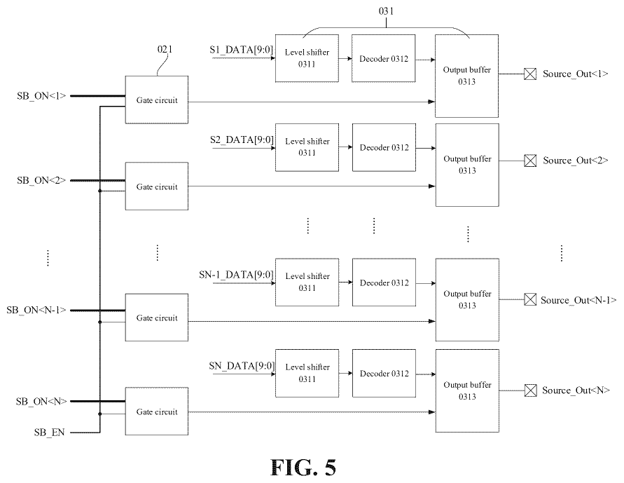

Optionally, FIG. 5 is a schematic structural diagram of still a further panel driving circuit according to some embodiments of the present disclosure. Referring to FIG. 5, it can be seen that each control sub-circuit 021 described in the embodiments of the present disclosure may include a gate circuit.

A first input terminal of the gate circuit may be coupled with the enable signal terminal SB_EN, and may be configured to receive the enable signal provided by the enable signal terminal SB_EN.

A second input terminal of the gate circuit may be coupled with the detection circuit 01 (not shown in FIG. 5) and may be configured to receive the first detection signal or the second detection signal output by the detection circuit 01.

An output terminal of the gate circuit may be coupled with the output circuit 03 and may be configured to output the first control signal based on the first detection signal and the enable signal; and output the second control signal based on the second detection signal and the enable signal.

Optionally, as shown in FIG. 5, the first input terminals of the gate circuits in the N control sub-circuits 021 may all be coupled with the same enable signal terminal SB_EN. The second input terminals of the gate circuits in the N control sub-circuits 021 may be coupled with the detection circuit 01 (not shown in FIG. 5) through the N terminals SB_ON<1>, SB_ON<2>, SB_ON<N−1>, and SB_ON<N> in one-to-one correspondence. The output terminals of the gate circuits in the N control sub-circuits 021 may be coupled with the N output sub-circuits 031 in the output circuit 03 in one-to-one correspondence.

Optionally, with continued reference to FIG. 5, it can be seen that each output sub-circuit 031 described in the embodiments of the present disclosure may include a level shifter (L/S) 0311, a decoder (DEC) 0312, and an output buffer 0313.

The level shifter 0311 may be configured to convert the potential of a reference signal. For example, the reference signal is boosted. The reference signal may refer to the data signal provided by a timing controller to the source driver, and then the source driver may process the data signal and then output to the display panel.

The decoder 0312 may be configured to perform digital-to-analog conversion processing on the reference signal after potential conversion. For example, the reference signal after potential conversion is converted from a digital signal to an analog signal.

The output buffer 0313 may be configured to buffer the signal output after the digital-to-analog conversion processing into the drive signal at the first slew rate based on the second control signal, and output to the display panel; and buffer the signal output after the digital-to-analog conversion processing into the drive signal at the second slew rate based on the first control signal, and output to the display panel.

Thus, referring to FIG. 5, it can also be seen that the level shifter 0311 may receive the reference signal. In FIG. 5, the reference signals received by input terminals of N level shifters 0311 in the N output sub-circuits 031 are respectively marked as S1_DATA[9:0], S2_DATA[9:0] . . . SN−1_DATA[9:0], and SN_DATA[9:0] in one-to-one correspondence. Furthermore, the level shifter 0311 may also be coupled with the decoder 0312, the decoder 0312 may also be coupled with the output buffer 0313, and the output buffer 0313 may also be respectively coupled with the gate circuit in the control sub-circuit 021 and the display panel. Here, the N output buffers 0313 in the N output sub-circuits 031 may be coupled with the output terminals of N gate circuits in the N control sub-circuits 021 in one-to-one correspondence. Besides, the N output buffers 0313 in the N output sub-circuits 031 may be coupled with the display panel through the N source output terminals Source_Out<1>, Source_Out<2> . . . Source_Out<N−1>, and Source_out<N> in one-to-one correspondence.

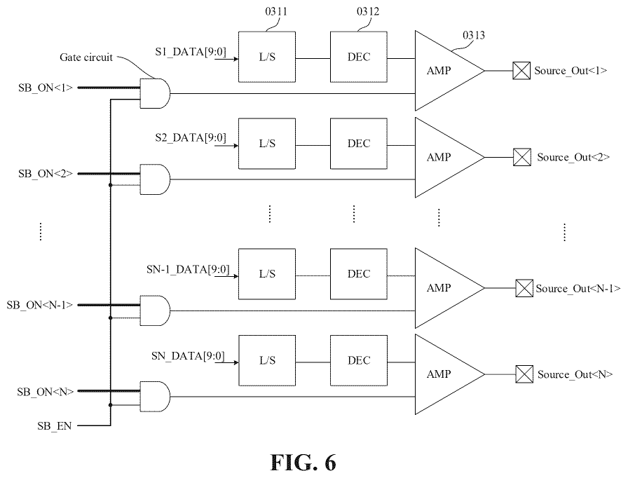

Optionally, FIG. 6 is a schematic structural diagram of still a further panel driving circuit according to some embodiments of the present disclosure. Referring to FIG. 6, it can be seen that the gate circuit may include an AND gate.

In combination with a processing logic of the AND gate, i.e., “when all inputs are the high potential H (logic 1) at the same time, the output is the high potential H, otherwise the output is the low potential L (logic 0)”, it can be known that for the X^{th} drive channel in the N drive channels, although the potential of the enable signal provided by the enable signal terminal SB_EN is the high potential, the terminal SB_ON<X> corresponding to the X^{th} drive channel outputs the first control signal of high potential indicating to boost the slew rate to the output buffer 0313 only when receiving the first detection signal also of high potential, Otherwise, in the case of receiving the second detection signal of low potential, the terminal SB_ON<X> corresponding to the X^{drive channel will output the second control signal of low potential indicating not to boost the slew rate to the output buffer 0313.}

In addition, FIG. 6 also schematically shows the level shifters 0311, the decoders 0312, and the output buffers 0313, The level shifters 0311 are shown as L/S modules; the decoders 0312 are shown as DEC modules; and the output buffers 0313 may include amplifiers (AMP). Combined with FIG. 6, it can also be seen that the slew rate boost solution according to the embodiments of the present disclosure can be realized by only adding the smallest semiconductor process units, the structure is simple and the cost is lower.

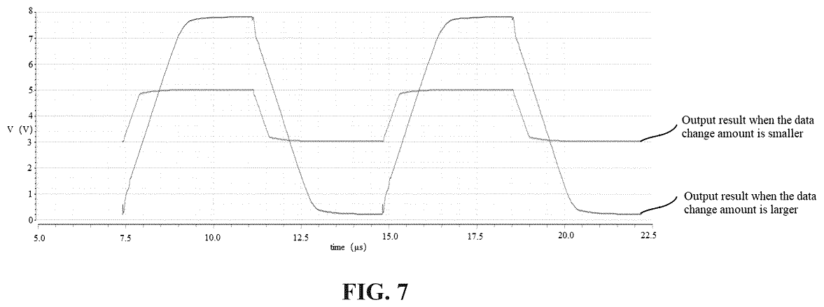

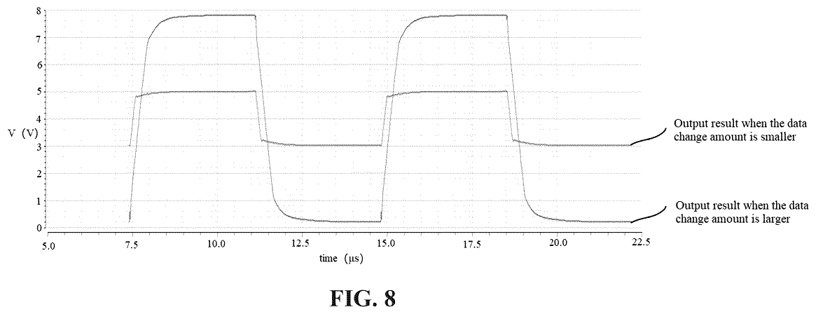

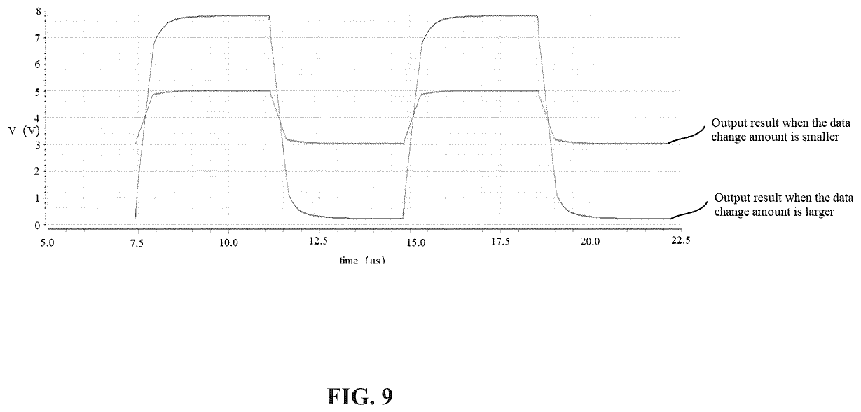

Based on the above embodiments, FIG. 7 shows an output simulation result of a panel driving circuit without slew rate boost; FIG. 8 shows an output simulation result of a panel driving circuit with general slew rate boost; and FIG. 9 shows an output simulation result of a panel driving circuit with proposed slew rate boost according to some embodiments of the present disclosure. The horizontal coordinate is time in μs; the vertical coordinate is the potential of the output drive signal in volts (V). Moreover, each of the simulation results shown in FIG. 7 to FIG. 9 includes an output result when the data change amount is larger and an output result when the data change amount is smaller. By comparing FIG. 7 to FIG. 9, it can be seen that compared with no slew rate boost solution and the general slew rate boost solution, the proposed slew rate boost solution according to the embodiments of the present disclosure not only enables the output circuit to output the drive signal quickly, that is, enables the potential of the drive signal to quickly reach a stable target potential (for example, 7.9V) due to the slew rate being boosted mainly when the data change amount is larger, but also reduces the current consumption. In this way, power consumption of the panel driving circuit can be optimized.

In summary, the embodiments of the present disclosure provide a panel driving circuit. The panel driving circuit includes a detection circuit, a control circuit, and an output circuit. For each of the plurality of drive channels, the detection circuit can output the first detection signal to the control circuit when the data change amount of the drive signal output through the drive channel is larger, so as to indicate the control circuit to output the control signal boosting the slew rate to the output circuit, so that the output circuit works at the boosted slew rate; the second detection signal can be output to the control circuit when the data change amount of the drive signal output through the drive channel is smaller, so as to indicate the control circuit to output the control signal not boosting the slew rate to the output circuit. That is, the slew rate can be boosted only for the drive channels with larger data change amount. In this way, the current consumption can be reduced.

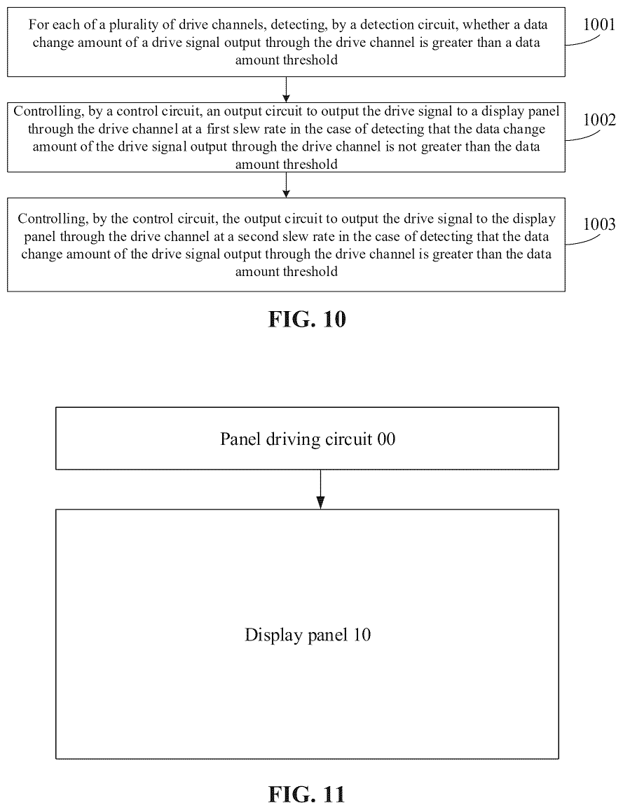

FIG. 10 is a flowchart of a method for driving a panel driving circuit according to some embodiments of the present disclosure, and the driving method may be applied to the panel driving circuit described in the above embodiments. The panel driving circuit outputs drive signals to a display panel through a plurality of drive channels, and the panel driving circuit includes a detection circuit, a control circuit, and an output circuit. As shown in FIG. 10, the driving method includes:
step 1001: for each of the plurality of drive channels, detecting, by the detection circuit, whether a data change amount of the drive signal output through the drive channel is greater than a data amount threshold;
step 1002: controlling, by the control circuit, the output circuit to output the drive signal to the display panel through the drive channel at a first slew rate in the case of detecting that the data change amount of the drive signal output through the drive channel is not greater than the data amount threshold; and
step 1003: controlling, by the control circuit, the output circuit to output the drive signal to the display panel through the drive channel at a second slew rate in the case of detecting that the data change amount of the drive signal output through the drive channel is greater than the data amount threshold;
wherein the second slew rate is a rate after the first slew rate is boosted.

Optionally, controlling, by the control circuit, the output circuit to output the drive signal to the display panel through the drive channel at the first slew rate may include:
outputting a second detection signal in the case of detecting, by the detection circuit, that the data change amount of the drive signal output through the drive channel is not greater than the data amount threshold;
outputting, by the control circuit, a second control signal based on the second detection signal and an enable signal, wherein the second control signal indicates not to boost a slew rate of the panel driving circuit in the drive channel; and
outputting, by the output circuit, the drive signal to the display panel through the drive channel at the first slew rate based on the second control signal.

Optionally, controlling, by the control circuit, the output circuit to output the drive signal to the display panel through the drive channel at the second slew rate may include:
outputting a first detection signal in the case of detecting, by the detection circuit, that the data change amount of the drive signal output through the drive channel is greater than the data amount threshold;
outputting, by the control circuit, a first control signal based on the first detection signal and the enable signal, wherein the first control signal indicates to boost the slew rate of the panel driving circuit in the drive channel; and
outputting, by the output circuit, the drive signal to the display panel through the drive channel at the second slew rate based on the first control signal.

Optionally, detecting, by the detection circuit, whether the data change amount of the drive signal output through the drive channel is greater than the data amount threshold may include:
detecting whether a difference between a data amount of the drive signal output through the drive channel at a current moment and a data amount of the drive signal output at another moment adjacent to the current moment is greater than a difference threshold;
determining that the data amount of the drive signal output through the drive channel is greater than the data amount threshold in the case of detecting that the difference between the data amount of the drive signal output through the drive channel at the current moment and the data amount of the drive signal output at another moment adjacent to the current moment is greater than the difference threshold; and
determining that the data amount of the drive signal output through the drive channel is not greater than the data amount threshold in the case of detecting that the difference between the data amount of the drive signal output through the drive channel at the current moment and the data amount of the drive signal output at another moment adjacent to the current moment is not greater than the difference threshold.

Optionally, the detection circuit may include a storage sub-circuit and a comparison sub-circuit; the storage sub-circuit stores the drive signal output through the drive channel at the current moment and the drive signal output through the drive channel at another moment adjacent to the current moment; and
detecting whether the difference between the data amount of the drive signal output through the drive channel at the current moment and the data amount of the drive signal output at another moment adjacent to the current moment is greater than the difference threshold may include:
comparing, by the comparison sub-circuit, whether the difference between the data amount of the drive signal output through the drive channel at the current moment and the data amount of the drive signal output at another moment adjacent to the current moment is greater than the difference threshold.

Optionally, the control circuit may include a plurality of control sub-circuits in one-to-one correspondence with the plurality of drive channels; the output circuit includes a plurality of output sub-circuits in one-to-one correspondence with the plurality of drive channels;
controlling, by the control circuit, the output circuit to output the drive signal to the display panel through the drive channel at the first slew rate in the case of detecting that the data change amount of the drive signal output through the drive channel is not greater than the data amount threshold may include:
controlling, by the control sub-circuit corresponding to the drive channel, the corresponding output sub-circuit to output the drive signal to the display panel through the drive channel at the first slew rate; and
controlling, by the control circuit, the output circuit to output the drive signal to the display panel through the drive channel at the second slew rate in the case of detecting that the data change amount of the drive signal output through the drive channel is greater than the data amount threshold includes:
controlling, by the control sub-circuit corresponding to the drive channel, the corresponding output sub-circuit to output the drive signal to the display panel through the drive channel at the second slew rate.

Optionally, potentials of the first detection signal and the second detection signal may be different.

Optionally, potentials of the first control signal and the second control signal may be different.

As the driving method may have basically the same embodiments and technical effects as the panel driving circuit described in the preceding embodiments, for the sake of brevity, the embodiments and technical effects of the driving method are not repeated here.

FIG. 11 is a schematic structural diagram of a display device according to some embodiments of the present disclosure. As shown in FIG. 11, the display device includes a display panel 10 and the panel driving circuit 00 as described in the above embodiments.

The panel driving circuit 00 is configured to output drive signals to the display panel 10 through a plurality of drive channels; and the display panel 10 is configured to display a picture based on the drive signals.

Thus, referring to FIG. 11, it can also be seen that the panel driving circuit 00 may be coupled with the display panel 10.

Furthermore, in combination with FIG. 1, it can be seen that the panel driving circuit 00 includes:
a detection circuit 01 configured to, for each of the plurality of drive channels, output a first detection signal in the case of detecting that a data change amount of the drive signal output through the drive channel is greater than a data amount threshold; and output a second detection signal in the case of detecting that the data change amount of the drive signal output through the drive channel is not greater than the data amount threshold;
a control circuit 02 configured to output a first control signal based on the first detection signal and an enable signal; and output a second control signal based on the second detection signal and the enable signal, wherein the first control signal indicates to boost a slew rate of the panel driving circuit in the drive channel, and the second control signal indicates not to boost the slew rate of the panel driving circuit in the drive channel; and
an output circuit 03 configured to output the drive signal to the display panel through the drive channel at a first slew rate based on the second control signal; and output the drive signal to the display panel through the drive channel at a second slew rate based on the first control signal, wherein the second slew rate is a rate after the first slew rate is boosted.

Optionally, the display device may be a liquid crystal display (LCD) device or any other product or component with a display function.

As the display device may have basically the same technical effects as the panel driving circuit described in the preceding embodiments, for the sake of brevity, the technical effects of the display device are not repeated here.

It should be noted that the terms used in the embodiments of the present disclosure are only configured to explain the embodiments, and are not intended to limit the present disclosure. Unless otherwise defined, the technical terms or scientific terms used in the embodiments of the present disclosure shall be taken to mean the ordinary meanings as understood by the ordinary skill in the art to which the present disclosure belongs.

For example, “first,” “second,” or “third” and similar words used in the description and claims of patent application of the present disclosure do not denote any order, quantity, or importance, but are merely configured to distinguish different constituents. “Connected” or “coupled” refers to electrically connected. Similarly, “a” or “one” and similar words are not intended to limit the number, but to denote the number of at least one. “Includes” or “contains” and similar words are intended to mean that the elements or objects before the “includes” or “contains” cover the elements or objects and equivalents thereof listed after the “includes” or “contains”, without excluding other elements or objects. “Upper,” “lower,” “left,” “right,” and the like are merely configured to indicate a relative positional relationship, and when the absolute position of a described object changes, the relative positional relationship may also change accordingly.

The foregoing descriptions are merely optional embodiments of the present disclosure, and are not intended to limit the present disclosure. Within the spirit and principles of the present disclosure, any modifications, equivalent substitutions, improvements, and the like are within the protection scope of the present disclosure.

1. A panel driving circuit for outputting drive signals to a display panel through a plurality of drive channels, the panel driving circuit comprising:
a detection circuit configured to, for each of the plurality of drive channels, output a first detection signal in a case of detecting that a data change amount of a drive signal output through the drive channel is greater than a data amount threshold; and output a second detection signal in a case of detecting that the data change amount of the drive signal output through the drive channel is not greater than the data amount threshold;
a control circuit configured to receive the first detection signal and the second detection signal, and output a first control signal based on the first detection signal and an enable signal; and output a second control signal based on the second detection signal and the enable signal, wherein the first control signal indicates to boost a slew rate of the panel driving circuit in the drive channel, and the second control signal indicates not to boost the slew rate of the panel driving circuit in the drive channel; and
an output circuit configured to receive the first control signal and the second control signal, and output the drive signal to the display panel through the drive channel at a first slew rate based on the second control signal; and output the drive signal to the display panel through the drive channel at a second slew rate based on the first control signal, wherein the second slew rate is a rate after the first slew rate is boosted.

2. The panel driving circuit according to claim 1, wherein the detection circuit is configured to:
determine that a data amount of the drive signal output through the drive channel is greater than the data amount threshold in a case of detecting that a difference between a data amount of the drive signal output through the drive channel at a current moment and a data amount of the drive signal output at another moment adjacent to the current moment is greater than a difference threshold; and
determine that the data amount of the drive signal output through the drive channel is not greater than the data amount threshold in a case of detecting that the difference between the data amount of the drive signal output through the drive channel at the current moment and the data amount of the drive signal output at another moment adjacent to the current moment is not greater than the difference threshold.

3. The panel driving circuit according to claim 2, wherein the detection circuit comprises:
a storage sub-circuit configured to store the drive signal output through the drive channel at the current moment and the drive signal output through the drive channel at another moment adjacent to the current moment; and
a comparison sub-circuit configured to compare whether the difference between the data amount of the drive signal output through the drive channel at the current moment and the data amount of the drive signal output at another moment adjacent to the current moment is greater than the difference threshold, and output the first detection signal and/or the second detection signal based on a comparison result.

4. The panel driving circuit according to claim 1, wherein the control circuit comprises:
a plurality of control sub-circuits in one-to-one correspondence with the plurality of drive channels, each of the control sub-circuits being configured to output the first control signal based on the received first detection signal and the enable signal; and output the second control signal based on the received second detection signal and the enable signal.

5. The panel driving circuit according to claim 4, wherein the control sub-circuit comprises a gate circuit; wherein
a first input terminal of the gate circuit is coupled with an enable signal terminal and configured to receive the enable signal provided by the enable signal terminal;
a second input terminal of the gate circuit is coupled with the detection circuit and configured to receive the first detection signal or the second detection signal output by the detection circuit; and
an output terminal of the gate circuit is coupled with the output circuit and configured to output the first control signal based on the first detection signal and the enable signal; and output the second control signal based on the second detection signal and the enable signal.

6. The panel driving circuit according to claim 5, wherein the gate circuit comprises an AND gate.

7. The panel driving circuit according to claim 1, wherein the output circuit comprises:
a plurality of output sub-circuits in one-to-one correspondence with the plurality of drive channels, each of the output sub-circuits being configured to output the drive signal to the display panel through a corresponding drive channel at the first slew rate based on the received second control signal; and output the drive signal to the display panel through a corresponding drive channel at the second slew rate based on the received first control signal.

8. The panel driving circuit according to claim 7, wherein the output sub-circuit comprises:
a level shifter configured to convert a potential of a reference signal;
a decoder configured to perform digital-to-analog conversion processing on the reference signal after potential conversion; and
an output buffer configured to buffer the signal output after the digital-to-analog conversion processing into the drive signal at the first slew rate based on the second control signal and output to the display panel; and buffer the signal output after the digital-to-analog conversion processing into the drive signal at the second slew rate based on the first control signal, and output to the display panel.

9. The panel driving circuit according to claim 5, wherein first input terminals of gate circuits in the plurality of control sub-circuits are coupled with a same enable signal terminal.

10. The panel driving circuit according to claim 1, wherein potentials of the first detection signal and the second detection signal are different.

11. The panel driving circuit according to claim 2, wherein potentials of the first control signal and the second control signal are different.

12. A method for driving a panel driving circuit, wherein the panel driving circuit outputs drive signals to a display panel through a plurality of drive channels, and the panel driving circuit comprises a detection circuit, a control circuit, and an output circuit; and the method comprises:
for each of the plurality of drive channels, detecting, by the detection circuit, whether a data change amount of a drive signal output through the drive channel is greater than a data amount threshold;
controlling, by the control circuit, the output circuit to output the drive signal to the display panel through the drive channel at a first slew rate in a case of detecting that the data change amount of the drive signal output through the drive channel is not greater than the data amount threshold; and
controlling, by the control circuit, the output circuit to output the drive signal to the display panel through the drive channel at a second slew rate in a case of detecting that the data change amount of the drive signal output through the drive channel is greater than the data amount threshold;
wherein the second slew rate is a rate after the first slew rate is boosted.

13. The method according to claim 12, wherein controlling, by the control circuit, the output circuit to output the drive signal to the display panel through the drive channel at the first slew rate comprises:
outputting a second detection signal in a case of detecting, by the detection circuit, that the data change amount of the drive signal output through the drive channel is not greater than the data amount threshold;
outputting, by the control circuit, a second control signal based on the second detection signal and an enable signal, wherein the second control signal indicates not to boost a slew rate of the panel driving circuit in the drive channel; and
outputting, by the output circuit, the drive signal to the display panel through the drive channel at the first slew rate based on the second control signal.

14. The method according to claim 13, wherein controlling, by the control circuit, the output circuit to output the drive signal to the display panel through the drive channel at the second slew rate comprises:
outputting a first detection signal in a case of detecting, by the detection circuit, that the data change amount of the drive signal output through the drive channel is greater than the data amount threshold;
outputting, by the control circuit, a first control signal based on the first detection signal and the enable signal, wherein the first control signal indicates to boost the slew rate of the panel driving circuit in the drive channel; and
outputting, by the output circuit, the drive signal to the display panel through the drive channel at the second slew rate based on the first control signal.

15. The method according to claim 12, wherein detecting, by the detection circuit, whether the data change amount of the drive signal output through the drive channel is greater than the data amount threshold comprises:
detecting whether a difference between a data amount of the drive signal output through the drive channel at a current moment and a data amount of the drive signal output at another moment adjacent to the current moment is greater than a difference threshold;
determining that the data amount of the drive signal output through the drive channel is greater than the data amount threshold in a case of detecting that the difference between the data amount of the drive signal output through the drive channel at the current moment and the data amount of the drive signal output at another moment adjacent to the current moment is greater than the difference threshold; and
determining that the data amount of the drive signal output through the drive channel is not greater than the data amount threshold in a case of detecting that the difference between the data amount of the drive signal output through the drive channel at the current moment and the data amount of the drive signal output at another moment adjacent to the current moment is not greater than the difference threshold.

16. The method according to claim 15, wherein the detection circuit comprises a storage sub-circuit and a comparison sub-circuit; the storage sub-circuit stores the drive signal output through the drive channel at the current moment and the drive signal output through the drive channel at another moment adjacent to the current moment;
detecting whether the difference between the data amount of the drive signal output through the drive channel at the current moment and the data amount of the drive signal output at another moment adjacent to the current moment is greater than the difference threshold comprises:
comparing, by the comparison sub-circuit, whether the difference between the data amount of the drive signal output through the drive channel at the current moment and the data amount of the drive signal output at another moment adjacent to the current moment is greater than the difference threshold.

17. The method according to claim 13, wherein the control circuit comprises a plurality of control sub-circuits in one-to-one correspondence with the plurality of drive channels; the output circuit comprises a plurality of output sub-circuits in one-to-one correspondence with the plurality of drive channels;
controlling, by the control circuit, the output circuit to output the drive signal to the display panel through the drive channel at the first slew rate in a case of detecting that the data change amount of the drive signal output through the drive channel is not greater than the data amount threshold comprises:
controlling, by the control sub-circuit corresponding to the drive channel, a corresponding output sub-circuit to output the drive signal to the display panel through the drive channel at the first slew rate; and
controlling, by the control circuit, the output circuit to output the drive signal to the display panel through the drive channel at the second slew rate in the case of detecting that the data change amount of the drive signal output through the drive channel is greater than the data amount threshold comprises:
controlling, by the control sub-circuit corresponding to the drive channel, the corresponding output sub-circuit to output the drive signal to the display panel through the drive channel at the second slew rate.

18. The method according to claim 14, wherein potentials of the first detection signal and the second detection signal are different.

19. The method according to claim 14, wherein potentials of the first control signal and the second control signal are different.

20. A display device comprising: a display panel and a panel driving circuit;
wherein the panel driving circuit is configured to output drive signals to the display panel through a plurality of drive channels; the display panel is configured to display a picture based on the drive signals; and
the panel driving circuit comprises:
a detection circuit configured to, for each of the plurality of drive channels, output a first detection signal in a case of detecting that a data change amount of a drive signal output through the drive channel is greater than a data amount threshold; and output a second detection signal in a case of detecting that the data change amount of the drive signal output through the drive channel is not greater than the data amount threshold;
a control circuit configured to output a first control signal based on the first detection signal and an enable signal; and output a second control signal based on the second detection signal and the enable signal, wherein the first control signal indicates to boost a slew rate of the panel driving circuit in the drive channel, and the second control signal indicates not to boost the slew rate of the panel driving circuit in the drive channel; and
an output circuit, configured to output the drive signal to the display panel through the drive channel at a first slew rate based on the second control signal; and output the drive signal to the display panel through the drive channel at a second slew rate based on the first control signal, wherein the second slew rate is a rate after the first slew rate is boosted.
